(19) United States
(12) Patent Application Publication
(10) Pub. No.: US 2005/0249572 A1
(43) Pub. Date: Nov. 10, 2005

(54) Steel hollow-head screw

(76) Inventors: Alain Virgl, Pont Sur Yonne (FR); Maxime Leroux, Odomez (FR)

Correspondence Address: Blakely Sokoloff Taylor & Zafman, 12400 Wilshire Boulevard, 7th Floor, Los Angeles, CA, 90025, US

(21) Appl. No.: 10/520,541

(22) PCT Filed: Jul. 3, 2003
(86) PCT No.: PCT/FR03/02068

§ 371 Date: Jan. 4, 2005

(30) Foreign Application Priority Data
Jul. 5, 2002 (FR) 02/08443

(51) Int. Cl. F16B 23/00

(52) U.S. Cl. 411/402

(57) ABSTRACT

The invention relates to a hollow-head screw which is made by simple successive cold working operations using a steel comprising between 0.15 and 0.25% of carbon.

The present invention relates to the field of screws.

More precisely, the present invention relates to the field of steel screws having socket heads.

The present invention applies particularly, but not exclusively, to making screws for securing wheels to motor vehicles.

Numerous steel screws have already been proposed.

Nevertheless, the person skilled in the art is aware of the difficulty of making a socket in the head of such a screw.

At present, most steel socket-head screws are made using methods that include heat treatment.

The person skilled in the art is aware that without such heat treatment, the depth that can be reached by the socket has until now been very limited, typically to a maximum of 0.4 to 0.5 times the diameter.

An object of the present invention is thus to propose novel means enabling a socket-head screw to be made that presents a deep socket, while avoiding any heat treatment.

An object of the present invention, and thus a characteristic thereof, is to make a screw presenting a socket head in which the socket has a depth that is greater than 0.6 times, and advantageously greater than 0.8 times, and preferably greater than 0.85 times the diameter of the socket.

In the context of the present invention, this object is achieved by a socket-head screw made merely by successive cold working operations using a steel having a carbon content lying in the range 0.15% to 0.25%, preferably in the range 0.19% to 0.23%.

According to another advantageous characteristic of the present invention, the percentage of manganese lies in the range 1.00% to 1.50%, and preferably in the range 1.00% to 1.30%.

According to another advantageous characteristic of the present invention, the percentage of boron lies in the range 10 parts per million (ppm) to 50 ppm, and preferably in the range 20 ppm to 50 ppm.

According to another advantageous characteristic of the present invention, the material constituting the screw includes microadditions of titanium, preferably in the range 0.01% to 0.10%, and preferably in the range 0.02% to 0.05%.

The Applicant has found that the correlation between titanium microadditions limiting the phenomenon of recrystallization, and the controlled cooling during rolling sequences, makes it possible to obtain a ferrito-pearlitic metallurgical structure that is very fine and very uniform.

According to another advantageous characteristic of the present invention, the raw rolled wire used for making the screws presents the following mechanical properties: minimum tensile strength (Rm)>580 megapascals (MPa) and minimum yield point (Re)>340 MPa. The Applicant has also found that such mechanical properties are particularly well adapted to forging screws without having recourse to conventional heat treatment operations: globular annealing before forging; and quenching+tempering after forging.

Also preferably, the wire presents ductility Z %>65%.

Other characteristics, objects, and advantages of the present invention appear on reading the following detailed description with reference to the accompanying drawing given as non-limiting examples, and in which:

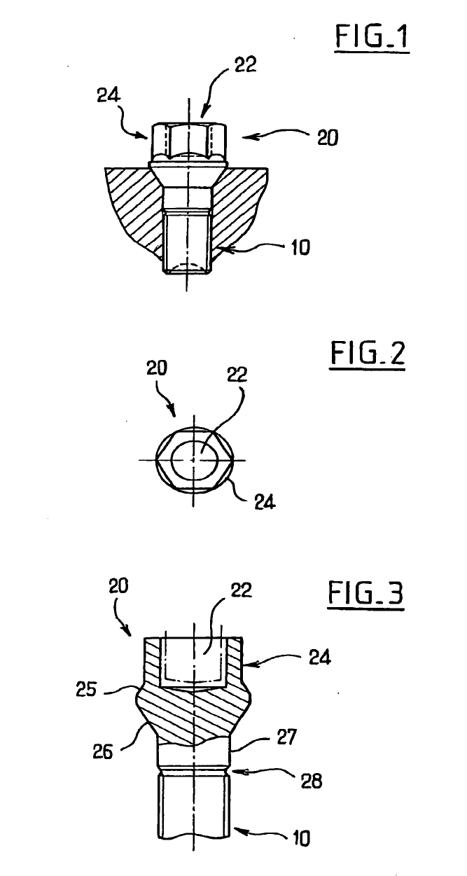

FIG. 1 is a diagrammatic side view of a screw in accordance with the present invention;

FIG. 2 is an end view of the screw; and

FIG. 3 is a longitudinal section view of a screw constituting a particular and non-limiting embodiment of the present invention.

Accompanying FIGS. 1 to 3 are diagrams showing a screw in accordance with the present invention.

Nevertheless, the present invention is not limited in any way to the particular dispositions shown in the accompanying figures, whether concerning the shape or the dimensions of the threaded portion 10, of the threads themselves, or of the head 20, and in particular of the socket 22 formed therein.

Nevertheless, it should be observed that in the non-limiting embodiment shown in the accompanying figures, the head 20 possesses an outside surface 24 of hexagonal section, while the socket 22 possesses an inside surface that is circularly cylindrical.

By way of non-limiting example, such a head may have a socket 22 with an inside diameter equal to 11.5 millimeters (mm), and a depth equal to 9.8 mm.

Furthermore, and still in non-limiting manner, it should be observed that in the particular and preferred embodiment shown in the accompanying figures, the segment 24 of hexagonal section is connected to the threaded portion 10 successively via a first cone 25 flaring towards the threaded portion, by a second cone 26 converging towards the same threaded portion, a smooth cylinder 27, and a groove 28.

In the context of the present invention, the material constituting the screw preferably satisfies the following characteristics:
C content: 0.19% to 0.23%;
Si content: 0.30% to 0.40%;
Mn content: 1.00% to 1.30%;
P content: 0.025% max;
S content: 0.015% max;
Cr content: 0.14% to 0.18%;
Mo content: 0.05% max;
Cu content: 0.25% max;
B content: 0.0020% to 0.0050% max;
Ni content: 0.18% max;
Al content: 0.02% to 0.06%;
Ti content: 0.02% to 0.05%; and
N content: 0.012% max.

The screw is preferably made using rolled or drawn wire satisfying the following mechanical characteristics:
Rm: 580 MPa to 650 MPa;
minimum Re: 340 MPa;
minimum elongation (A): 25%;
minimum Z: 65%.

After work hardening to a ratio of 50%, the screw presents the following characteristics:
Re: 640 MPa to 900 MPa;
Rm: 800 MPa to 950 MPa;
minimum A: 12%;
minimum U-notch fracture toughness (KCU): 70 Joules per square centimeter (J/cm²).

As mentioned above, the Applicant has found that this composition enables screws to be made merely by cold working, without requiring any heat treatment.

Naturally, the present invention is not limited to the particular embodiments described above, but extends to any variant within the spirit of the invention.

1. A socket-head screw made merely by successive cold working operations using a steel having a carbon content lying in the range 0.15% to 0.25%.

2. A screw according to claim 1, characterized by the fact that the carbon content lies in the range 0.19% to 0.23%.

3. A screw according to claim 1 or claim 2, characterized by the fact that it has a socket head in which the depth of the socket is greater than 0.6 times and preferably greater than 0.8 times its diameter.

4. A screw according to any one of claims 1 to 3, characterized by the fact that the manganese content lies in the range 1.00% to 1.50%, and preferably in the range 1.00% to 1.30%.

5. A screw according to any one of claims 1 to 4, characterized by the fact that the boron content lies in the range 10 ppm to 50 ppm, and preferably in the range 20 ppm to 50 ppm.

6. A screw according to any one of claims 1 to 5, characterized by the fact that its constituent material includes microadditions of titanium.

7. A screw according to any one of claims 1 to 6, characterized by the fact that it includes 0.01% to 0.10% titanium, and preferably 0.02% to 0.05%.

8. A screw according to any one of claims 1 to 7, characterized by the fact that the silicon content lies in the range 0.30% to 0.40%.

9. A screw according to any one of claims 1 to 8, characterized by the fact that the chromium content lies in the range 0.14% to 0.18%.

10. A screw according to any one of claims 1 to 9, characterized by the fact that the sulfur content is 0.015% max.

11. A screw according to any one of claims 1 to 10, characterized by the fact that it is made using a wire presenting the following mechanical properties: Rm>580 MPa and Re>340 MPa.

12. A screw according to any one of claims 1 to 11, characterized by the fact that it is made using a wire presenting ductility Z %>65%.

13. A screw according to any one of claims 1 to 12, characterized by the fact that it is made using the following materials:
C content: 0.19% to 0.23%;
Si content: 0.30% to 0.40%;
Mn content: 1.00% to 1.30%;
P content: 0.025% max;
S content: 0.015% max;
Cr content: 0.14% to 0.18%;
Mo content: 0.05% max;
Cu content: 0.25% max;
B content: 0.0020% to 0.0050% max;
Ni content: 0.18% max;
Al content: 0.02% to 0.06%;
Ti content: 0.02% to 0.05%; and
N content: 0.012% max.

14. The use of a screw in accordance with any one of claims 1 to 13 in making screws for securing wheels to motor vehicles.
